(19) United States
(12) Patent Application Publication
(10) Pub. No.: US 2019/0308909 A1
(43) Pub. Date: Oct. 10, 2019

(54) SINTERED CERAMICS

(71) Applicant: BMM Ventures, LLC, Salisbury, NC (US)

(72) Inventors: Claudia Belli, Roma (IT); Felix Ast, Mezocorona (IT); Fritz Moedinger, Bressanone Brixen (IT); Berthold Mueller, Salisbury, NC (US)

(73) Assignee: BMM Ventures, LLC, Salisbury, NC (US)

(21) Appl. No.: 16/304,936

(22) PCT Filed: May 10, 2017
(86) PCT No.: PCT/US2017/031905

§ 371 Date: Nov. 27, 2018

Related U.S. Application Data
(60) Provisional application No. 62/333,953, filed on May 10, 2016.

(51) Int. Cl. C04B 28/02; C04B 18/02; C04B 22/06

(52) U.S. Cl. CPC C04B 28/021; C04B 2103/0095; C04B 22/062; C04B 18/023

(57) ABSTRACT

A man-made aggregate or a masonry unit may be made by adding impound residues and mixing the impound residues with other residues, ceramic materials and/or additives to form an admixture. The impound residues may also be mixed with synthetic or organic polymers. The impound residues may not conform to the requirements of ASTM C618-15. The admixture may be subjected to a thermal process that allows for a ceramic conversion of the ceramic components of the mix used.

### CROSS REFERENCE TO RELATED PATENT APPLICATIONS

This application claims the benefit of and priority to International Application No. PCT/US2017/031905, filed on May 10, 2017, which the claims the priority to U.S. Provisional Application No. 62/333,953, filed on May 10, 2016, both of which are hereby incorporated by reference in their entireties.

### TECHNICAL FIELD AND BACKGROUND OF THE INVENTION

The present invention relates to the field of ceramics and more particularly to a method of producing beneficial materials using Coal Combustion Waste (CCW) and/or a combination of Biomass Combustion Waste (BCW). The present invention includes ceramic combustion byproduct based microporous granulates and/or porous or non-masonry elements. The products made according to the present invention are based on combustion and power and/or heating stating wastes and byproducts and on other materials exhibiting ceramic properties or not bound by organic or synthetic polymers prior to the ceramic, thermal, process.

Commercial power generating facilities (including coal, biomass, and others), heating facilities, and other incineration facilities often produce many byproducts in addition to heat and power. These byproducts include Coal Combustion Waste (CCW), Biomass Combustion Waste (BCW), Fly Ash, Biomass Ash, and Raw or Calcined Natural Pozzolan or substances having a pozzolanic effect. Indeed, energy grids in countries around the world are often dependent on power generation facilities which produce these byproducts in large volumes. For a number of reasons, recent legislation has introduced stringent requirements for disposal and impounding of these products, including CCW. In particular, some legislation has set a standard for CCW which may include, at a national level, ASTM C618-15. Importantly, CCW and BCW do not meet current legislative standards, including ASTM C618-15, and CCW and BCW, therefore, are difficult and expensive to store, dispose, or otherwise impound.

Further, the use of pure and non-contaminated coal combustion products in ceramics has never found a widespread application. The use of CCW mixed residues in a ceramic product is novel. Likewise, the use of BCW byproducts in a ceramic product is novel.

Thus, there is a need in the art for a beneficial use of such byproducts, including CCW and BCW, which may obviate the need for storage, disposal, or impoundment. Further, there is a need that these materials be beneficially used in a ceramic process.

### BRIEF SUMMARY OF THE INVENTION

It is therefore an object of the present invention to provide a method for making ceramic products from CCW byproducts, BCW byproducts, and other waste byproducts, where the byproducts may not conform to ASTM C618-15. It is a further object of the present invention to provide a product made from CCW byproducts and other waste byproducts, where the byproducts may not conform to ASTM C618-15. For instance, Fly Ash may conform to ASTM C618-15 whereas CCW and BCW byproducts may not conform. ASTM C618-15 is expressly incorporated herein by reference. As used herein, the ASTM C618-15 standard includes byproducts conforming to the Chemical Requirements shown in Table 1 below and the Physical Requirements shown in Table 2 below:

TABLE 1
Chemical Requirements

| | Class | | |
|---|---|---|---|
| | N | F | C |
| Silicon dioxide (SiO₂) plus | 70.0 | 70.0 | 50.0 |
| aluminum oxide (Al₂O₃) plus | | | |
| Iron oxide (Fe₂O₃). min, % | | | |
| Sulfur trioxide (SO₃), max, % | 4.0 | 5.0 | 5.0 |
| Moisture content, max, % | 3.0 | 3.0 | 3.0 |
| Loss on Ignition, max, % | 10.0 | 6.0^{A} | 6.0 |

^{A}The use of Class F pozzolan containing up to 12.0% loss on ignition may be approved by the user if either acceptable performance records or laboratory test results are made available.

TABLE 2
Physical Requirements

| | Class | | |
|---|---|---|---|
| | N | F | C |
| Fineness: | | | |
| Amount retained when wet-sieved on 45 μm | 34 | 34 | 34 |
| (No. 325) sieve, max, % | | | |
| Strength activity Index:^{A} | | | |
| With portland cement, at 7 days, min, | 75^{B} | 75^{B} | 75^{B} |
| percent of control | | | |
| With portland cement, at 28 days, min, | 75^{B} | 75^{B} | 75^{B} |
| percent of control | | | |
| Water requirement, max, percent of control | 115 | 105 | 105 |
| Soundness:^{C} | | | |
| Autoclave expansion or contraction, max, % | 0.8 | 0.8 | 0.8 |
| Uniformity requirements: | | | |
| The density and fineness of Individual | | | |
| samples shall not vary from the average | | | |
| established by the ten preceding tests, | | | |
| or by all preceding tests if the | | | |
| number is less than ten, by more than: | | | |
| Density, max variation from average, % | 5 | 5 | 5 |
| Percent retained on 45-μm (No. 325), max | 5 | 5 | 5 |
| variation, percentage points from average | | | |

^{A}The strength activity index with portland cement is not to be considered a measure of the compressive strength of concrete containing the fly ash or natural pozzolan. The mass of fly ash or natural pozzolan specified for the test to determine the strength activity index with portland cement is not considered to be the proportion recommended for the concrete to be used in the work. The optimum amount of fly ash or natural pozzolan for any specific project is determined by the required properties of the concrete and other constituents of the concrete and is to be established by testing. Strength activity index with portland cement is a measure of reactivity with a given cement and is subject to variation depending on the source of both the fly ash or natural pozzolan and the cement
^{B}Meeting the 7 day or 28 day strength activity index will indicate specification compliance.
^{C}If the fly ash or natural pozzolan will constitute more than 20% by mass of the cementitious material in the project mixture, the test specimens for autoclave expansion shall contain that anticipated percentage. Excessive autoclave expansion is highly significant in cases where water to cementitious material ratios are low, for example, in block or shotcrete mixtures.

As used herein, the following definitions apply: “impoundment residues” are Coal Combustion Waste (CCW) admixtures stored in wet or dry impoundments; “ashes” are combustion byproducts, either collected from filters or from the bottom of the furnace, from the combustion of fossil fuels, biomass or wastes; “raw materials” are materials and substances exhibiting ceramic properties or fillers that can be used in addition or substitution to materials or substances exhibiting ceramic properties; “ceramic materials” might encompass, but are not limited to, clay, fireclay, shale, coal combustion ashes etc. . . . ; “non-ceramic raw materials” might encompass cellulosic substances, biomass combustion ashes etc. . . . ; “polymers” are defined as substances that are formed by long chains of molecules and can be natural (organic), such as proteins, sugars or resins, or synthetic such as, for example, water glass; “masonry units” might be defined as an element of size, shape and weight such to be handled by a person and used in construction works; and “granulate” might define an agglomerate of regular or irregular spherical or not elements.

According to the present invention, the polymers may be synthetic or organic. For instance, sugar or protein hydrolysates would be organic polymers. Further, Waterglass would constitute a synthetic polymer as would resins.

According to the present invention, combustion byproducts contaminated or not by other products such as boiler blowdown water, metal cleaning waste water, fuel pile runoff and plant service cooling water residues in addition to materials brought there by storm water etc. can be used beneficially in the production of shaped masonry units and granulates.

The physical, chemical and mineralogical characteristics of these materials depend intimately on the origin, for example combustion technology applied, and the source of the fuel. These characteristics included but are not limited to grain size distribution, residual C and sulfur content.

The study of the various source materials that can be used as a raw material according to the present invention indicates a wide variety of composition and, in certain cases, inhomogeneity of the source materials. This inhomogeneity must be compensated, in order to allow the combustion by-products to be beneficially used, with ceramic materials exhibiting a better homogeneity in order to be able to control the outcome of the ceramic process.

It is, therefore, an object of the present invention to provide for the beneficial the use of impoundment CCW. It is a further objection of the present invention to provide for the beneficial use of biomass combustion residues as a component in manufacturing. It is a further object of the present invention to provide beneficial concurrent use of coal combustion residues, from impoundments or otherwise, and biomass combustions residues. It is a further object of the present invention to utilize polymers in combination with the aforesaid substances. It is a further object of the present invention to provide methods of using the aforementioned substances in association or separately.

These and other aspects of the invention are achieved by the manufacturing, using any shaping technology, of granulates and masonry units adding sintering aids and polymers to the raw mix of raw materials. The products manufactured according to this invention might be used in construction, especially but not limited to: thermosoil granulates (insulation); horticulture; granulates (greenhouse, agriculture, green roof); asphalt granulates (draining); bio-filtration (water and waste water for example); water management—river regulation, flash flood regulation (basins filled with open pore bloated clay are used to store excess water keeping the flood area accessible); road salt (open pore granules impregnated with salt solution); man-made aggregate for light weight concrete products and applications; building construction blocs; and/or facing bricks and lintels.

The granulated products are mainly intended to be used in reclamation and landscaping. The product is an admixture of water retaining open nanopore ash based ceramic granules, soil and compost. The irregular shape of the aggregate may be an advantage.

Contrary to bloated clay of shale, open pore, light weight aggregates for concrete may have many advantages. Closed pore products (such as closed por granulates) may also be utilized and their use is expressly contemplated as well. Iron oxide may be used as a sintering aid to achieve “closed”, vitrified surfaces but iron oxide is not used as a bloating agent as in conventional manufacturing of bloated clay.

Open nanopore aggregates, contrary to closed cell aggregates, allow for a concrete product with better humidity permeability hence improving indoor climate conditions (humidity can be transported from the inside to the outside of the building). Open pore aggregates can be sold to render product manufacturers as well. The irregular shape of the aggregate may be an advantage.

The raw mix may include combustion residues and other products. The application of the invention can have an impact on the density of the manufactured objects.

According to an aspect of the present invention, the method and products disclosed may have beneficial: impact on the surface qualities, such a color, of the manufactured objects; impact on the environmental quality, leaching for example, of the manufactured objects; impact on the safety of workers in the production process; impact on the emissions into air of the ceramic conversion cycle; impact on emissions into the ground of the stored raw materials (i.e., the risk of leaching of heavy metals into the ground from the impoundments can be reduced); impact on public safety (i.e. risk from the breach of dams from impoundments can be reduced); impact on emission of greenhouse gases (i.e.—usually in the calculation of greenhouse gas emissions the conversion rate of the C contained in the fuel is considered to be >99% whereas in effect it is usually <90%. Generated energy required in the ceramic conversion process hence generally is considered to not contribute, double accounting of emissions is generally to be avoided, to the overall greenhouse gas emissions of the process object of this invention); and impact on release of dust (i.e.—no dust from the dry surface of impoundments is released into the environment).

Further, according to another aspect of the invention, the use of polymers may aid in the shaping and handling of the unfired products and the used sintering aids will aid in achieving appropriate firing temperatures that will avoid creating of glassy phases that could result in product defects.

The invention may allow the reduction of the quantity of bloating, such as ferric oxides, or pore forming, such as saw-dust, paper sludge or polystyrene, agents required to obtain a given desirable product density.

According to one embodiment of the invention, a method of making a man-made aggregate may include the steps of adding impound residues and mixing the impound residues with other residues, ceramic materials and/or additives to form an admixture.

According to another embodiment of the invention, the impound residues may not conform to any of the requirements of ASTM C618-15.

According to another embodiment of the invention, the method of making a man-made aggregate may include the additional step of subjecting the admixture to a thermal process that allows for a ceramic conversion of the ceramic components of the mix used.

According to another embodiment of the invention, the method of making a man-made aggregate may include the additional step of adding an additive that is contributing to eutectic conditions.

According to another embodiment of the invention, the method of making a man-made aggregate may include the additional step of step of adding an oxidizing agent. The oxidizing agent may be potash or soda.

According to another embodiment of the invention, the ceramic conversion may occur in a kiln.

According to another embodiment of the invention, the ceramic conversion may occur in a tunnel or rotary kiln.

According to another embodiment of the invention, the ceramic conversion process occurs with excess oxygen or under reducing conditions.

According to another embodiment of the invention, the ceramic conversion process can occur using externally or internally fired kilns.

According to another embodiment of the invention, the ceramic conversion process can occur adding combustible substances to the ceramic body. For instance, in embodiments using a rotary kiln, coal or petcoke could be added to the body in order to achieve self-firing. According to such an embodiment, the fuel added to the body would generate enough heat to fire itself.

According to another embodiment of the invention, the admixture of the components can be made either wet or dry.

According to another embodiment of the invention, each one of the components of the admixture can undergo a previous treatment such as sizing, removing of impurities, grinding, annealing or a combination of sizing, removing of impurities, grinding, and annealing.

According to one embodiment of the invention, a method of making a masonry unit aggregate may include the steps of adding impound residues and mixing the impound residues with other residues, ceramic materials and/or synthetic polymers to form an admixture.

According to one embodiment of the invention, a method of making masonry units may include the steps of adding impound residues and mixing other residues, ceramic materials and/or additives.

According to one embodiment of the invention, a method of making masonry units may include the steps of adding impound residues and mixing other residues, ceramic materials and/or synthetic polymers.

According to another embodiment of the invention, the method of making a masonry unit may include the additional step of subjecting the admixture to a thermal process that allows for a ceramic conversion of the ceramic components of the mix used.

According to another embodiment of the invention, the method of making masonry units may include the additional step of adding an additive that is contributing to eutectic conditions.

According to another embodiment of the invention, the method of making masonry units may include the additional step of step of adding an oxidizing agent. The oxidizing agent may be potash or soda.

According to another embodiment of the invention, the impound residues do not conform to any of the requirements of ASTM C618-15.

According to another embodiment of the invention, the method of the present invention may include the additional step of subjecting the admixture to a thermal process that allows for a ceramic conversion of the ceramic components of the mix used.

According to another embodiment of the invention, the method of the present invention may include the additional step of adding an additive that is contributing to eutectic conditions.

According to another embodiment of the invention, the method of the present invention may include the additional step of of adding an oxidizing agent.

According to another embodiment of the invention, the oxidizing agent may be a potash.

According to another embodiment of the invention, the oxidizing agent may be soda.

According to another embodiment of the invention, the ceramic conversion occurs in a kiln.

According to another embodiment of the invention, the ceramic conversion process occurs with excess oxygen or under reducing conditions.

According to another embodiment of the invention, the ceramic conversion process can occur using externally or internally fired kilns.

According to another embodiment of the invention, the admixture of the components can be made either wet or dry.

According to another embodiment of the invention, each one of the components of the admixture can undergo a previous treatment such as sizing, removing of impurities, grinding, annealing or a combination of sizing, removing of impurities, grinding, and annealing.

According to one embodiment of the invention, a method of making a masonry unit may include the steps of adding impound residues and mixing the impound residues with other residues, ceramic materials and/or additives to form an admixture.

According to such a method, another embodiment includes the impound residues do not conform to any of the requirements of ASTM C618-15.

According to another embodiment of the invention, the method may include the additional step of subjecting the admixture to a thermal process that allows for a ceramic conversion of the ceramic components of the mix used.

According to another embodiment of the invention, the method may include the additional step of adding an additive that is contributing to eutectic conditions.

According to another embodiment of the invention, the method may include the additional step of adding an oxidizing agent.

According to another embodiment of the invention, the oxidizing agent may be a potash.

According to another embodiment of the invention, the oxidizing agent is soda.

According to another embodiment of the invention, the ceramic conversion may occur in a kiln.

According to another embodiment of the invention, the ceramic conversion process may occur with excess oxygen or under reducing conditions.

According to another embodiment of the invention, the ceramic conversion process may occur using externally or internally fired kilns.

According to another embodiment of the invention, the admixture of the components may be made either wet or dry.

According to another embodiment of the invention, each one of the components of the admixture may undergo a previous treatment such as sizing, removing of impurities, grinding, annealing or a combination of sizing, removing of impurities, grinding, and annealing.

According to one embodiment of the invention, a method of making a masonry unit may include the steps of adding impound residues and mixing the impound residues with other residues, ceramic materials and/or additives to form an admixture.

According to another embodiment of the invention, the impound residues of the masonry unit do not conform to any of the requirements of ASTM C618-15.

According to another embodiment of the invention, a method of making a masonry unit may include the additional step of subjecting the admixture to a thermal process that allows for a ceramic conversion of the ceramic components of the mix used.

According to another embodiment of the invention, a method of making a masonry unit may include the additional step of adding an additive that is contributing to eutectic conditions.

According to another embodiment of the invention, a method of making a masonry unit may include the additional step of adding an oxidizing agent. The oxidizing agent may be potash and/or soda. 44. The ceramic conversion may occur in a kiln. The ceramic conversion process may occur with excess oxygen or under reducing conditions. The ceramic conversion process may occur using externally or internally fired kilns. The components can be made either wet or dry.

According to another embodiment of the method of making a masonry unit, each one of the components of the admixture can undergo a previous treatment such as sizing, removing of impurities, grinding, annealing or a combination of sizing, removing of impurities, grinding, and annealing.

### BRIEF DESCRIPTION OF THE DRAWINGS

Features, aspects and advantages of the present invention are understood when the following detailed description of the invention is read with reference to the accompanying drawings, in which:

FIG. 1 is a diagram of the production process; and

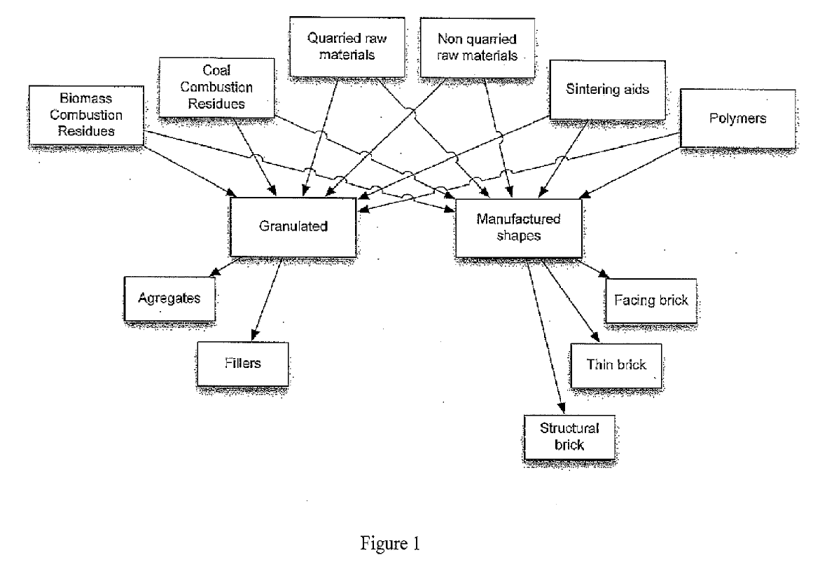

FIG. 2 is a graph which visualizes the inhomogeneity of the source materials.

### DETAILED DESCRIPTION OF THE INVENTION

A preferred embodiment according to the invention is described in detail below. A typical embodiment used in the production of granulates and masonry elements may be based upon fly ash with a residual organic content that makes them unsuitable for addition to concrete. This embodiment may feature the following chemical analysis:

| | Si | Al | Fe | Ti | Na | Mg | K | Ca | S tot | Sb | As | Ba | Cd | Crₜₒₜ |
|---|---|---|---|---|---|---|---|---|---|---|---|---|---|---|
| AVG | 18.31 | 11.05 | 2,315.65 | 0.52 | 0.29 | 424.83 | 1,163.24 | 2,614.49 | 0.11 | 10.94 | 2.72 | 1,044.16 | 2.13 | 278.31 |
| STDEV | 1.40 | 1.28 | 1,200.87 | 0.06 | 0.23 | 639.00 | 450.37 | 1,505.86 | 0.06 | 14.58 | 1.18 | 566.55 | 1.12 | 166.58 |
| Max | 20.95 | 12.58 | 4,756.00 | 0.59 | 0.70 | 1,394.00 | 1,473.00 | 4,471.00 | 0.22 | 31.30 | 4.50 | 2,491.00 | 3.50 | 586.00 |
| Min | 16.24 | 9.13 | 1.89 | 0.37 | 0.12 | 0.25 | 1.15 | 3.45 | 0.03 | 0.90 | 1.40 | 717.80 | 0.50 | 123.50 |

| | Co | Cu | Pb | Mn | Mo | Ni | Se | Sr | Sn | Te | Tl | V | Zn | Hg |
|---|---|---|---|---|---|---|---|---|---|---|---|---|---|---|
| AVG | 58.03 | 390.82 | 47.38 | 231.29 | 4.73 | 53.23 | 0.52 | 767.72 | 15.69 | 1.29 | 1.16 | 108.42 | 159.94 | 0.72 |
| STDEV | 12.12 | 530.89 | 43.01 | 177.95 | 2.56 | 11.88 | 0.30 | 438.79 | 17.08 | 0.06 | 0.37 | 30.62 | 153.32 | 0.19 |
| Max | 81.60 | 1,386.00 | 110.80 | 684.00 | 9.30 | 71.90 | 1.10 | 1,904.00 | 38.60 | 1.40 | 1.70 | 152.00 | 411.00 | 1.20 |
| Min | 43.60 | 28.20 | 9.20 | 113.00 | 1.20 | 34.30 | 0.20 | 485.30 | 3.10 | 1.20 | 0.50 | 42.80 | 28.20 | 0.60 |

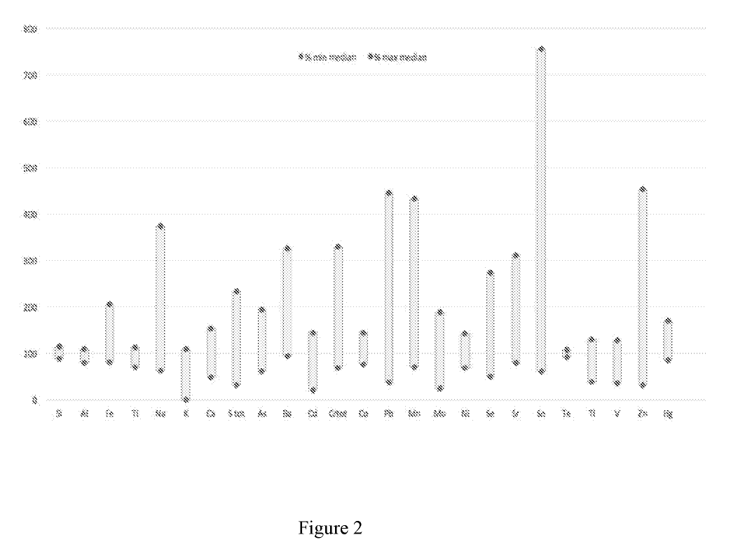

The graphic shown in FIG. 2 visualizes the inhomogeneity of source materials.

Using these ashes 4 different admixtures have been prepared and tested:

A17: 75% CCW 25% Sodium silicate 50° BE
B14—B15: 67.5% CCW, 22.5% % Sodium silicate 50° BE, 10% clay
E05-E15: 67.5% CCW, 15% Sodium silicate 50° BE, 7.5% NaOH, 10% clay
All admixtures are cured at 120° C. for 18 hrs.

When fired at 1,175 F 2 hrs hold, the following results have been obtained:

Fired to 1175F - 2 Hour Hold
As Received Data

| | Dry Length | Fired Length | Shrinkage | Initial Wt. | LOI |
|---|---|---|---|---|---|
| Sample ID | (mm) | (mm) | (%) | (g) | (%) |
| A17 | 124.12 | 122.26 | 1.499 | 97.5 | 4.614 |
| B14 | 113.55 | 109.69 | 3.399 | 85.2 | 4.797 |
| B15 | 117.30 | 116.05 | 1.066 | 86.8 | 4.831 |
| E15 | 115.63 | 114.87 | 0.657 | 88.1 | 5.762 |
| E05 | 117.37 | 116.25 | 0.954 | 79.6 | 5.710 |

| Absorptions | Dry Wt. | 24-hr Wt. | 5-hr boil | CWA | BWA | |
|---|---|---|---|---|---|---|
| Sample ID | (g) | (g) | (g) | (%) | (%) | C/B |
| A17 | 93.2 | 105.1 | 110.7 | 12.77 | 18.78 | 0.68 |
| B14 | 81.3 | 88.5 | 90 | 8.86 | 10.70 | 0.83 |
| B15 | 82.8 | 90.1 | 91.4 | 8.82 | 10.39 | 0.85 |
| E15 | 83.3 | 94.6 | 95.2 | 13.57 | 14.29 | 0.95 |
| E05 | 75.3 | 86.8 | 105.4 | 15.27 | 39.97 | 0.38 |

| Compression | Length | Width | Peak Load | Compressive Strength |
|---|---|---|---|---|
| Sample ID | (in) | (in) | (lbs) | (psi) |
| A17 | 1.17 | 0.69 | 2614 | 3219.4 |
| B14 | 1.01 | 0.65 | 4674 | 7119.4 |
| B15 | 1.00 | 0.64 | 3931 | 6172.4 |
| E15 | 1.08 | 0.72 | 1063 | 1358.1 |
| E05 | 1.13 | 0.76 | 1472 | 1716.6 |

A sintered ceramic and process of producing a sintered ceramic according to the invention has been described with reference to specific preferred embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims. It is envisioned that other embodiments may perform similar functions and/or achieve similar results. Any and all such equivalent embodiments and examples are within the scope of the present invention and are intended to be covered by the appended claims.

What is claimed is:

1. A method of making a man-made aggregate comprising the steps of:
adding impound residues and
mixing the impound residues with other residues, ceramic materials and/or additives to form an admixture.

2. The method of claim 1 wherein the impound residues do not conform to any of the requirements of ASTM C618-15.

3. The method of claim 2 comprising the additional step of subjecting the admixture to a thermal process that allows for a ceramic conversion of the ceramic components of the mix used.

4. The method of claim 3 further comprising the step of adding an additive that is contributing to eutectic conditions.

5. The method of claim 3 further comprising the step of adding an oxidizing agent.

6. The method of claim 5 wherein the oxidizing agent is as potash.

7. The method of claim 5 wherein the oxidizing agent is soda.

8. The method of claim 3 wherein the ceramic conversion occurs in a kiln.

9. The method of claim 3 wherein the ceramic conversion process occurs with excess oxygen or under reducing conditions.

10. The method of claim 3 wherein the ceramic conversion process can occur using externally or internally fired kilns.

11. The method of claim 3 wherein the admixture of the components can be made either wet or dry.

12. The method of claim 3 wherein each one of the components of the admixture can undergo a previous treatment such as sizing, removing of impurities, grinding, annealing or a combination of sizing, removing of impurities, grinding, and annealing.

13. A method of making a man-made aggregate comprising the steps of:
adding impound residues and
mixing the impound residues with other residues, ceramic materials and/or synthetic polymers to form an admixture.

14. The method of claim 13 wherein the impound residues do not conform to any of the requirements of ASTM C618-15.

15. The method of claim 14 comprising the additional step of subjecting the admixture to a thermal process that allows for a ceramic conversion of the ceramic components of the mix used.

16. The method of claim 15 further comprising the step of adding an additive that is contributing to eutectic conditions.

17. The method of claim 15 further comprising the step of adding an oxidizing agent.

18. The method of claim 17 wherein the oxidizing agent is a potash.

19. The method of claim 17 wherein the oxidizing agent is soda.

20. The method of claim 15 wherein the ceramic conversion occurs in a kiln.

21. The method of claim 15 wherein the ceramic conversion process occurs with excess oxygen or under reducing conditions.

22. The method of claim 15 wherein the ceramic conversion process can occur using externally or internally fired kilns.

23. The method of claim 15 wherein the admixture of the components can be made either wet or dry.

24. The method of claim 15 wherein each one of the components of the admixture can undergo a previous treatment such as sizing, removing of impurities, grinding, annealing or a combination of sizing, removing of impurities, grinding, and annealing.

25. A method of making a masonry unit comprising the steps of:
adding impound residues and
mixing the impound residues with other residues, ceramic materials and/or additives to form an admixture.

26. The method of claim 25 wherein the impound residues do not conform to any of the requirements of ASTM C618-15.

27. The method of claim 26 comprising the additional step of subjecting the admixture to a thermal process that allows for a ceramic conversion of the ceramic components of the mix used.

28. The method of claim 26 further comprising the step of adding an additive that is contributing to eutectic conditions.

29. The method of claim 26 further comprising the step of adding an oxidizing agent.

30. The method of claim 29 wherein the oxidizing agent is a potash.

31. The method of claim 29 wherein the oxidizing agent is soda.

32. The method of claim 27 wherein the ceramic conversion occurs in a kiln.

33. The method of claim 27 wherein the ceramic conversion process occurs with excess oxygen or under reducing conditions.

34. The method of claim 27 wherein the ceramic conversion process can occur using externally or internally fired kilns.

35. The method of claim 27 wherein the admixture of the components can be made either wet or dry.

36. The method of claim 27 wherein each one of the components of the admixture can undergo a previous treatment such as sizing, removing of impurities, grinding, annealing or a combination of sizing, removing of impurities, grinding, and annealing.

37. A method of making a masonry unit comprising the steps of:
adding impound residues and
mixing the impound residues with other residues, ceramic materials and/or additives to form an admixture.

38. The method of claim 37 wherein the impound residues do not conform to any of the requirements of ASTM C618-15.

39. The method of claim 38 comprising the additional step of subjecting the admixture to a thermal process that allows for a ceramic conversion of the ceramic components of the mix used.

40. The method of claim 39 further comprising the step of adding an additive that is contributing to eutectic conditions.

41. The method of claim 39 further comprising the step of adding an oxidizing agent.

42. The method of claim 41 wherein the oxidizing agent is as potash.

43. The method of claim 41 wherein the oxidizing agent is soda.

44. The method of claim 39 wherein the ceramic conversion occurs in a kiln.

45. The method of claim 39 wherein the ceramic conversion process occurs with excess oxygen or under reducing conditions.

46. The method of claim 39 wherein the ceramic conversion process can occur using externally or internally fired kilns.

47. The method of claim 39 wherein the admixture of the components can be made either wet or dry.

48. The method of claim 39 wherein each one of the components of the admixture can undergo a previous treatment such as sizing, removing of impurities, grinding, annealing or a combination of sizing, removing of impurities, grinding, and annealing.
